(19) United States
(12) Patent Application Publication
(10) Pub. No.: US 2010/0268460 A1
(43) Pub. Date: Oct. 21, 2010

(54) NAVIGATION SYSTEM WITH PREDICTIVE MULTI-ROUTING AND METHOD OF OPERATION THEREOF

(75) Inventors: Feng Wan, Mountain View, CA (US); Jie Huang, Santa Clara, CA (US); Yi-Chung Chao, San Jose, CA (US)

Correspondence Address: LAW OFFICES OF MIKIO ISHIMARU, 333 W. EL CAMINO REAL, SUITE 330, SUNNYVALE, CA, 94087, US

(73) Assignee: TELENAV, INC., Sunnyvale, CA (US)

(21) Appl. No.: 12/424,495

(22) Filed: Apr. 15, 2009

(51) Int. Cl. G01C 21/00

(52) U.S. Cl. 701/210; 701/200; 701/207

(57) ABSTRACT

A method of operation of a navigation system with predictive multi-routing includes: calculating a primary route; predicting a probable deviation location on the primary route; calculating a non-primary route for the probable deviation location; and sending the primary route, the non-primary route, or a combination thereof for displaying on a device.

### TECHNICAL FIELD

The present invention relates generally to a navigation system, and more particularly to a navigation system with predictive multi-routing.

### BACKGROUND ART

Modern portable consumer and industrial electronics, especially client devices such as navigation systems, cellular phones, portable digital assistants, and combination devices, are providing increasing levels of functionality to support modern life including location-based information services. Numerous technologies have been developed to utilize this new functionality. Some of the research and development strategies focus on new technologies while others focus on improving the existing and mature technologies. Research and development in the existing technologies can take a myriad of different directions.

As users become more empowered with the growth of mobile navigation devices, new and old paradigms begin to take advantage of this new device space. There are many technological solutions to take advantage of this new device location opportunity. One existing approach is to use location information to provide navigation services such as a GPS (Global Positioning System) navigation system for a car or on a mobile device such as a cell-phone, PDA (Portable Digital Assistant) or portable computer. However, the ability for users to use location information to generate a navigation route does not automatically translate to providing a safe, quick, and effective method of navigation for each individual. An effective means to make navigation systems more useful to individuals is still required.

For example, some individual drivers require a higher level of interactivity and performance from their navigation systems than other drivers. Such a navigation system must be able to respond to changing conditions encountered by the driver suitable for the situation.

Thus, a need remains for a navigation system with predictive multi-routing to efficiently create, manage, and present navigation information in a timely fashion for a variety of circumstances and situations. In view of the ever-increasing added features desired by consumers in their mobile client devices, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation a navigation system with predictive multi-routing including: calculating a primary route in a device, predicting probable deviation locations along the primary route, calculating the non-primary route, sending the primary route, the non-primary route or a combination thereof for displaying on a device.

The present invention provides a navigation system including: a routing engine for calculating a primary route, and calculating a non-primary route for the probable deviation location; a control unit, coupled to the routing engine, for predicting probable deviation locations on the primary route, and updating a navigation routing parameter with a multi-route parameter; a communication unit, coupled to the control unit, for sending the primary route, the non-primary route, or a combination thereof for displaying on a device.

Certain embodiments of the invention have other aspects in addition to or in place of those mentioned above. The aspects can become apparent to those skilled in the art from a reading of the following detailed description when taken with reference to the accompanying drawings.

### BRIEF DESCRIPTION OF THE DRAWINGS

FIG. 1 is a navigation system with predictive multi-routing in a first embodiment of the present invention.

FIG. 2 is a multimedia display interface of the navigation system of FIG. 1.

FIG. 3 is a memory map of the navigation system of FIG. 1.

FIG. 4 is a flow chart of a method of operation of the navigation system of FIG. 1.

FIG. 5 is a block diagram of the navigation system of FIG. 1.

FIG. 6 is a block diagram of a navigation system with predictive multi-routing in a second embodiment of the present invention.

FIGS. 7A, 7B, 7C and 7D are illustrations of a first example of the navigation system of FIG. 1.

FIGS. 8A, 8B, and 8C are illustrations of a second example of the navigation system of FIG. 1.

FIG. 9 is a flow chart of a method of operation of a navigation system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes can be made without departing from the scope of the present invention.

In the following description, numerous specific details are given to provide a thorough understanding of the invention. However, it can be apparent that the invention can be practiced without these specific details. In order to avoid obscuring the present invention, some well-known circuits, system configurations, and process locations are not disclosed in detail. Likewise, the drawings showing embodiments of the system are semi-diagrammatic and not to scale and, particularly, some of the dimensions are for the clarity of presentation and are shown greatly exaggerated in the drawing FIGs.

One skilled in the art would appreciate that the format with which navigation information is expressed is not critical to some embodiments of the invention. For example, in some embodiments, navigation information is presented in the format of (X, Y), where X and Y are two ordinates that define the geographic location, i.e., a position of a user.

In an alternative embodiment, navigation information is presented by longitude and latitude related information. In a further embodiment of the present invention, the navigation information also includes a velocity element comprising a speed component and a heading component.

The term “relevant information” referred to herein comprises the navigation information described as well as information relating to points of interest to the user, such as local business, hours of businesses, types of businesses, advertised specials, traffic information, maps, local events, and nearby community or personal information.

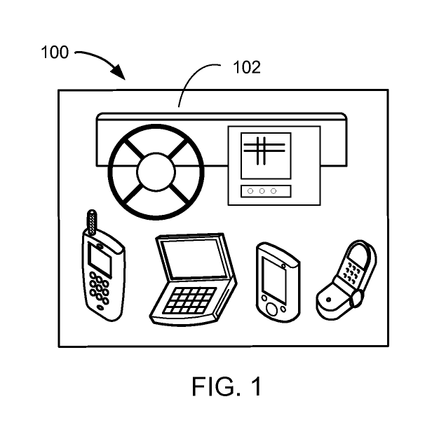

Referring now to FIG. 1, therein is a navigation system 100 with predictive multi-routing in a first embodiment of the present invention. A device 102 can be of any of a variety of mobile devices, such as a cellular phone, personal digital assistant, a notebook computer, automotive telematic navigation system, or other multi-functional mobile communication or entertainment devices having means for location monitoring, preferably, global positioning system (GPS) function, of the device 102.

The navigation system 100 is predictive because it predicts probable locations along a primary path where a deviation from the path is likely. The navigation system 100 is multi-routing because is calculates the route from multiple probable deviation locations to the final destination. The navigation system 100 can calculate the multiple routes from the multiple probable deviations locations in one single transaction in advance, rather than performing the same routing operation over multiple transactions.

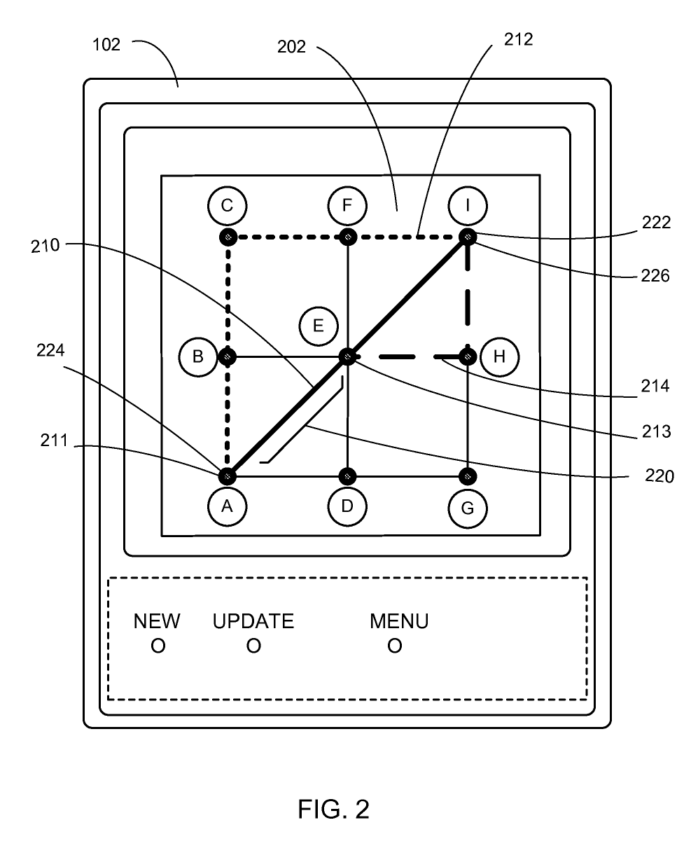

Referring now to FIG. 2, therein is a multimedia display interface 202 of the navigation system 100 of FIG. 1. The multimedia display interface 202 can present visual and audio navigation routing information. For example, the multimedia display interface 202 can present a primary route 210 along the route AEI, a first non-primary route 212 along the path ABCFI at a first probable deviation location 211, and a second non-primary route 214 along the route EHI at a second probable deviation location 213.

The primary route 210 can include an edge 220 representing a street or navigable path and a node 222 representing an intersection, a start location 224 and a target location 226. The primary route 210 is the best route from the start location 224 and the target location 226 calculated by the routing algorithm used by the navigation system 100.

The non-primary route 212 is an alternate route to the target location 226 from a probable deviation location 213 along the primary route 210. The non-primary route 212 is an alternate route from a probable deviation location 213 to the target location 226 calculated by the routine algorithm used by the navigation system 100.

In another example, the multimedia display interface 202 can present directional navigation information. In a further example, the multimedia display interface 202 can present audio navigation information such as navigation commands, directional commands, alerts, warnings, or any combination thereof.

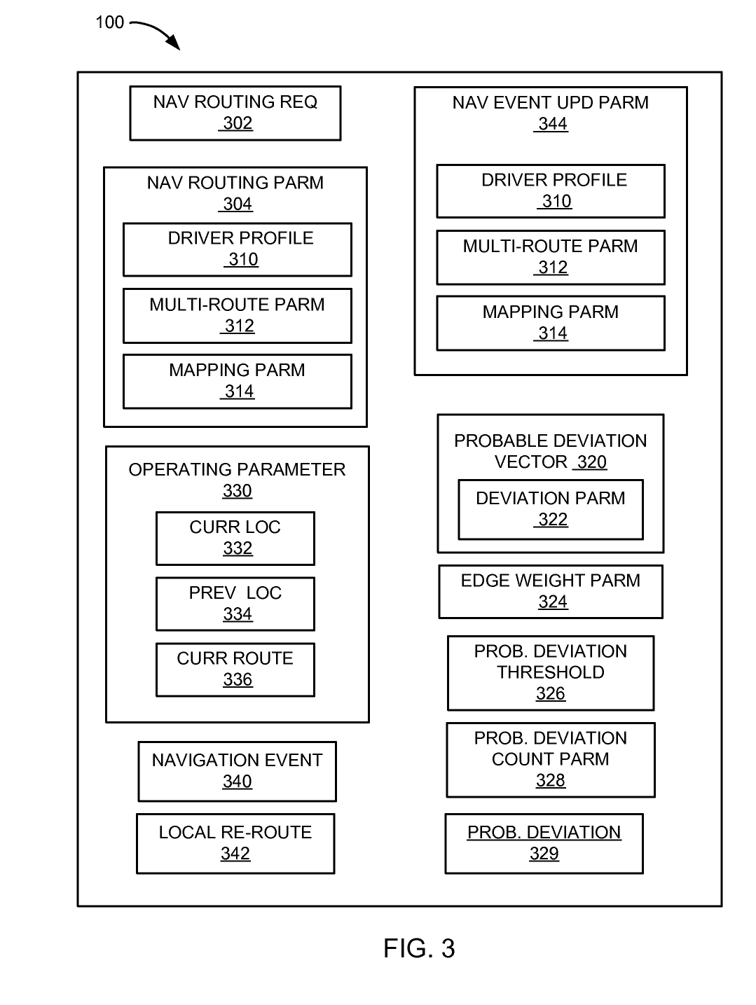

Referring now to FIG. 3, therein shown is a memory map of the navigation system 100 of FIG. 1. The memory map can include a navigation routing request 302, a navigation routing parameter 304, a driver profile 310, a multi-route parameter 312, a mapping parameter 314, a probable deviation vector 320, a deviation parameter 322, an edge weight parameter 324, a probable deviation threshold 326, a probable deviation count parameter 328, and a probability of deviation 329.

The probable deviation threshold 326 can define a value used to determine if the probability of deviation of a location along a primary route 210 of FIG. 2 is high enough to identify the location as a member of the probable deviation vector 320. The probable deviation count parameter 328 can represent the number of elements in the probable deviation vector 320. The memory map can also include an operating parameter 330, a current location 332, a previous location 334, a current routine 336, a navigation event 340, and a local re-route 342.

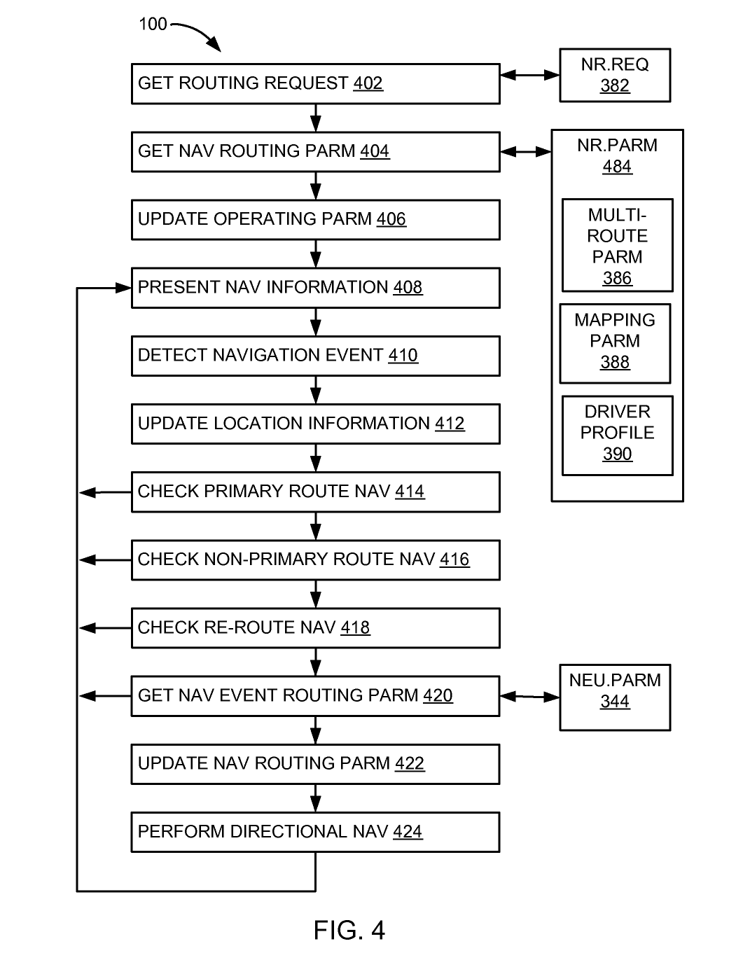

Referring now to FIG. 4, therein shown is a flow chart of a method of operation of navigation system 100 of FIG. 1. The navigation system 100 can calculate a route, such as a primary route 210 of FIG. 2, between two locations and operate the multimedia display interface 202 of the navigation system 100 by presenting navigation directions and mapping information for that route. In the flow chart of the method, as an example, each block is indicated by a number and successively higher block numbers follow one another unless explicitly indicated.

The navigation system 100 can receive the navigation routing request 302 of FIG. 3 to a target location 226 of FIG. 2 in a get routing request block 402. The navigation routing request 302 can include starting location, destination location, interim locations, driver identification, system identification, or any combination thereof.

The navigation system 100 can calculate the navigation routing parameter 304 of FIG. 3 in a get navigation routing parameter block 404. The navigation routing parameter 304 can include the multi-route parameter 312 of FIG. 3, the mapping parameter 314 of FIG. 3, the driver profile 310 of FIG. 3, control information, routing information, or any combination thereof.

The mapping parameter 314 can provide the graphical mapping information for the multi-route parameter 312. The mapping parameter 314 can include location-specific mapping information, graphical display information, resolution and size-specific display tiles, vector maps, nodes, edges, or any combination thereof.

The multi-route parameter 312 can describe a primary route 210 between two locations, as well as the non-primary route 212 of FIG. 2 from likely points of deviation along the primary route 210 to the final destination. The multi-route parameter 312 can include the primary route 210, the non-primary route 212, a local routing vector map, routing vector status information, or any combination thereof. The primary route 210 can be calculated using a variety of methods including least cost, shortest time, ease of navigation, least turns, least traffic, scenic route, or any combination thereof.

For example, the primary route 210 can include the edge 220 of FIG. 2 that represents a street and the node 222 of FIG. 2 that represents an intersection between two or more streets. The primary route 210 can include the edge 220 of FIG. 2 and node 222 of FIG. 2 that form a route between two locations.

The primary route 210 can be associated with the probable deviation vector 320 of FIG. 3 that can contain locations along the primary route 210 where there is a probability above the probable deviation threshold 326 of FIG. 3 of deviating from the primary route 210. The probable deviation threshold 326 can vary to increase or decrease the number of elements in the probable deviation vector 320.

Each edge 220 in the primary route 210 can be assigned the deviation parameter 322 of FIG. 3 that indicates the probability that a routing deviation could occur at the node 222 at the end of the edge 220. The probable deviation vector 320 can include the edge 220 in the primary route 210 based on the deviation parameter 322.

For example, the deviation parameter 322 for edge 220 in the primary route 210 can be calculated by assigning the edge weight parameter 324 of FIG. 3 to the edge 220 along the primary route 210. The edge weight parameter 324 can be calculated by combining potential deviation factors including missed turn, road speed transition, road priority, road type, ramp, tight turn, adjacent turn, or any combination thereof.

In a further example, the missed turn factor can represent the probability of missing the turn at the end of the edge 220 by going straight instead of making a turn. The road speed transition factor can represent the probability of missing a turn when transitioning from a higher speed road to a lower speed road. The ramp factor can represent the probability of missing a ramp exit from a highway. The tight turn factor can represent the probability of missing a tight turn. The adjacent turn factor can represent the probability of making a wrong turn if there are two street intersections close together.

The probable deviation vector 320 can be calculated from the edge weight parameter 324 in a variety of methods. For example, the probable deviation vector 320 can include the edge 220 where the edge weight parameter 324 is above the probable deviation threshold 326. In another example, the probable deviation threshold 326 can vary to lower the number of elements in the probable deviation vector 320 to reduce the amount of memory needed.

In another example, if there is a large gap in the distribution of edge weight parameters 324, then the edge 220 whose edge weight parameter 324 is greater than the other edge weight parameters 324 can be included in the probable deviation vector 320. In a further example, the probable deviation vector 320 can be calculated by selecting a specified number of the highest edge weight parameters 324 where the specified number is based on the probable deviation count parameter 328.

The get navigation routing parameter block 404 can calculate non-primary route 212 for the edges 220 in the probable deviation vector 320. The non-primary route 212 can include the route from the node 222 of FIG. 2 to the target location 226 of FIG. 2. For example, if there are two elements in the probable deviation vector 320, then the navigation system 100 can calculate two of the non-primary routes 212 for the primary route 210.

The navigation system 100 can update the operating parameter 330 of FIG. 3 in an update operating parameter block 406. The operating parameter 330 can provide the current state of the navigation system 100. The operating parameter 330 can include a current location 332, the previous location 334, a current route 336, route status, operating status, operating mode, or any combination thereof.

The navigation system 100 can present the navigation routing parameter 304 of FIG. 3 on the multimedia display interface 202 of the navigation system 100 in a present navigation information block 408. For example, the mapping parameter 314 of the navigation routing parameter 304 can include display tiles which can be displayed on the multimedia display interface 202. In a further example, the multi-route parameter 312 can include the navigation command information which can generate audio commands on the multimedia display interface 202 to indicate when to make a turn.

The navigation system 100 can detect the navigation event 340 of FIG. 3 in a detect navigation event block 410. If the navigation event 340 has not been detected or has not occurred, then the navigation system 100 can wait until the navigation event 340 is detected. The navigation event 340 of FIG. 3 can include a location change, a speed change, a deviation from routing command, a vehicle control usage, a vehicle control setting change, a vehicle instrument change, or any combination thereof.

The navigation system 100 can update the location information in an update location information block 412. The navigation system 100 can process the navigation event 340 and calculate the current location 332 of the navigation system 100. The navigation system 100 can update the operating parameter 330 with the current location 332 of FIG. 3 of the navigation system 100.

The navigation system 100 can process the current location 332 of FIG. 3 and determine if the navigation system 100 is on the primary route 210 of the multi-route parameter 312 in a check primary route navigation block 414. If the navigation system 100 is on the primary route 210 of the multi-route parameter 312, then control can pass to the present navigation information block 408 to update the multimedia display interface 202. If the navigation system 100 is not on the primary route 210 of the multi-route parameter 312, then the control can pass to a check non-primary route navigation block 416.

The navigation system 100 can process the current location 332 and determine if the navigation system 100 is on one of the non-primary route 212 of the multi-route parameter 312 in the check non-primary route navigation block 416. If the navigation system 100 is on the non-primary route 212 of the multi-route parameter 312, then the navigation system 100 can update the current route 336 of the operating parameter 330 and control can pass to the present navigation information block 408 to update the multimedia display interface 202. If the navigation system 100 is not one of the non-primary route 212 of the multi-route parameter 312, then the control can pass to a check re-route navigation block 418.

The navigation system 100 can determine if the navigation system 100 can calculate the local re-route 342 of FIG. 3 to navigate from the current location 332 to the primary route 210 or to the non-primary route 212 in the check re-route navigation block 418. The navigation system 100 can calculate the local re-route 342 using a variety of methods including backtracking, an immediate u-turn, depth first search, band-hull search, breadth first search, or any combination thereof.

For example, the navigation system 100 can calculate the local re-route 342 by identifying a set of nodes based on physical proximity to the primary route 210 and searching the set of nodes to find the local re-route 342 that intersects the primary route 210 or the non-primary route 212. If the navigation system 100 has sufficient local navigation information to calculate the local re-route 342 to a location on the primary route 210 or to one of the non-primary routes, then the navigation system 100 can update the current route 336 of the operating parameter 330 with the local re-route 342 and control can pass to the present navigation information block 408.

If the navigation system 100 cannot calculate a local re-route 342 to the primary route 210 or to the non-primary route 212, then the navigation system 100 can request a navigation event update routing parameter 344 and control can pass to a get navigation event update parameter block 420.

The navigation system 100 can calculate the navigation event update parameter 344 of FIG. 4 in the get navigation event routing parameter block 420. The navigation event update parameter 344 can include the multi-route parameter 312 of FIG. 3, the mapping parameter 314 of FIG. 3, the driver profile 310 of FIG. 3, control information, routing information, or any combination thereof. Control can pass to an update navigation routine parameter block 422.

The navigation system 100 can compare a navigation event update parameter 244 to existing navigation information to determine if the multi-route parameter 312 can provide new routing information in the update navigation routing parameter block 422. If the multi-route parameter 312 can provide a new current route *, then the navigation system 100 can update the navigation routing information and control can pass to the present navigation information block 408.

The navigation system 100 can check the routing vector map status information in the multi-route parameter 312 to determine if the current location 332 is in a region that does not support additional navigation routing. For example, the current location 332 may be in an undeveloped area without roads, a large parking lot, a parking structure, an area without current routing information, or any combination thereof.

If the navigation system 100 is in a region that does not support additional navigation routing, then control can pass to a perform directional navigation block 424. The navigation system 100 can present a directional navigation solution to navigate from the current location to the nearest location on the primary route or on one of the non-primary route 212 in the perform directional navigation block 424. The directional navigation solution can calculate the nearest location on the primary route or on one of the non-primary route 212 and can indicate the relative direction to that location on the multimedia display interface 202 of the navigation system 100.

The navigation system 100 can then detect the next occurrence of the navigation event 340 and update the current location 332 of the navigation system 100. If the current location 332 is on the primary route or on one of the non-primary routes, then the operating parameter 330 is updated and control can pass to the present navigation information block 408. If the current location 332 is not on the primary route or on one of the non-primary routes, then control can pass back to the perform directional navigation block 424. The perform directional navigation block 424 can be repeated until the navigation system 100 reaches a location on the primary route or on one of the non-primary route 212.

It has been discovered that the present invention provides a navigation system 100 with predictive multi-routing that can provide navigation information to the user in areas where there is insufficient routing or mapping information by operating in a local or directional navigation mode. The navigation system can provide useful navigation information using local or direction navigation to direct the user to a location where there is sufficient routing and mapping information available and a primary route may be computed.

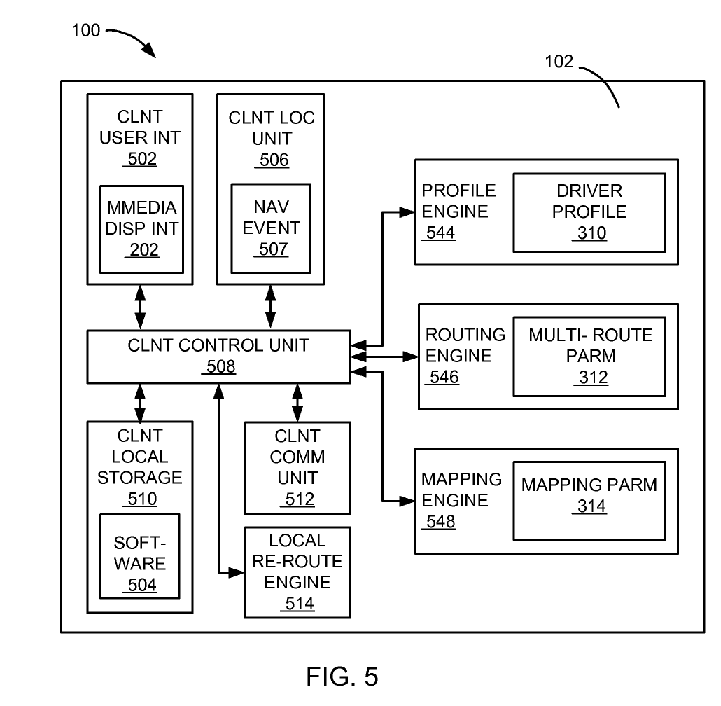

Referring now to FIG. 5, therein is shown a block diagram of the navigation system 100 of FIG. 1. FIG. 5 shows a single device embodiment of the navigation system 100 with predictive multi-routing where the device 102 can include all components necessary to perform predictive multi-route local navigation.

The device 102, for example, can include a client user interface 502 having a multimedia display interface 202, a client location unit 506, such as a GPS unit, a client control unit 508, such as a processor, a software 504, a client local storage 510, a local re-route engine 514, a client communication unit 512, a profile engine 544, a routing engine 546 and a mapping engine 548. The software 504 includes the method of operation of the navigation system 100 or portions thereof.

For illustrative purposes, the navigation system 100 with predictive multi-routing is shown with the device 102 encompassing the functionality in a single unit, although it is understood that any individual functional block can be implemented either locally or remotely on a different device. For example, the routing engine 546 of the device 102 can be implemented as a remote process on another device.

The client user interface 502 can provide command and data inputs to the device 102. The client user interface 502 can include the multimedia display interface 202, a key pad, a touchpad, soft-keys, a keyboard, a microphone, or any combination thereof, to provide data and command inputs to the device 102.

The multimedia display interface 202 can present visual and audio information such as maps, text, video, images, audio commands, audio notifications, audio warning, or any combination thereof. The multimedia display interface 202 can include a flat panel display, projector, cathode-ray tube display, heads up display, speakers, headphones, buzzers, or any combination thereof.

Presenting visual information on the multimedia display interface 202 can include displaying images, graphics, video, text or any combination thereof on the screen or display of the multimedia display interface 202. Presenting audio information on the multimedia display interface 202 can include playing voice, music, audio clips or any combination thereof on the speakers, headphones or buzzers of the multimedia display interface 202.

The client location unit 506 can provide location information and be implemented in many ways. For example, the client location unit 506 can be a global positioning system (GPS), inertial navigation system, cell-tower location system, accelerometer location system, or any combination thereof. The client location unit 506 can include the active and passive components, such as microelectronics or an antenna.

The client location unit 506 can detect the navigation event 340. The navigation event 340 can include location change, speed change, deviation from routing command, vehicle control usage, vehicle control setting change, vehicle instrument change, or any combination thereof.

The local re-route engine 514 can calculate local or directional routes to locations that exist in the navigation routing parameter 304. The local re-route 342 of FIG. 3 can include street navigation information to define a route between the current location and a location on a known route. The directional route can include a directional navigation command to a point on a known route.

The client control unit 508 can execute the software 504 and can provide the intelligence of the device 102 for interaction with the client user interface 502, the multimedia display interface 202, the client location unit 506, the client local storage 510, the client communication unit 512, the profile engine 544, the routing engine 546 and the mapping engine 548. The client control unit 508 can also execute the software 504 for other functions pertinent to a navigation device.

The client local storage 510 can be a volatile memory, a nonvolatile memory, an internal memory, an external memory, or a combination thereof. For example, the client local storage 510 can be a nonvolatile storage such as non-volatile random access memory (NVRAM), Flash memory, or disk storage or a volatile storage such as static random access memory (SRAM).

The client local storage 510 can store the software 504, setup data, multimedia data, photos, text, sounds recordings, video and other data for the operation of the device 102 as a navigation device. The client local storage 510 can also store the relevant information, such as maps, route information, traffic information, advertisement and point of interest (POI), navigation routing entries, driver information, or any combination thereof. The client local storage 510 can also store recorded, imaged, sampled or created relevant information.

The client communication unit 512 can couple with the communication path to communicate with other devices. The client communication unit 512 can include active and passive components, such as microelectronics or an antenna.

The profile engine 544 can create, store, update, and retrieve the driver profile 310. The profile engine 544 can be implemented as an integrated hardware component of the device 102 or as a distinct separate hardware, software, or combination system that provides access to the driver profile information. For example, the profile engine 544 can be implemented as a software module that accesses driver profile information stored in the client local storage 510.

The driver profile 310 can describe the behavior, tendencies, and history of a driver. The driver profile 310 can include any number of parameters such as a driver preferences parameter, a driver proficiency parameter, a driver location history, a driver vehicle history, a driver traffic parameter, a driver environmental history, or any combination thereof.

The routing engine 546 can create, store, update and retrieve the multi-route parameter 312 using the navigation routing parameter 304 and the driver profile 310. The routing engine 546 can be implemented as a hardware, software or combination component. For example, the routing engine 546 can be implemented as software running on the client control unit 508 accessing the navigation routing parameter 304 and the driver profile 310 stored in the client local storage 510.

The multi-route parameter 312 can describe the route between two locations. The multi-route parameter 312 can include a primary route, non-primary routes, vector maps, node and edge weighing information, navigation commands, or any combination thereof.

The mapping engine 548 can create, store, update and retrieve the mapping parameter 314 for the multi-route parameter 312. The mapping engine 548 can be implemented as a hardware, software, or combination component. For example, the mapping engine 548 can be implemented as software running on the client control unit 508 accessing a mapping database stored in the client local storage 510.

The mapping parameter 314 can describe the geographical and navigational features along a route. The mapping parameter 314 can include location-specific mapping information, graphical display information, resolution and size-specific display tiles, vector maps, images, points of interest, or any combination thereof.

The device 102 can implement the method of the flow chart of FIG. 3 of the navigation system 100 with predictive multi-routing of FIG. 3. Each block of the flow chart can be implemented using a combination of functional modules of the device 102.

The client user interface 502 can receive the navigation routing request 302 for the get routing request block 402. The client user interface 502 can present visual and audio information on the multimedia display interface 202 for the present navigation information block 408.

The client location unit 506 can detect the navigation event 340 for the detect navigation event block 410. The client location unit 506 can provide the location of the device to update the current location in the update location information block 412.

The routing engine 546 can calculate the navigation routing parameter 304 in the get navigation routing parameter block 404. The routing engine 546 can calculate the navigation routing parameter 304 based on the driver profile 310 provided by the profile engine 544. The navigation routing parameter 304 can include the mapping parameter 314 provided by the mapping engine 548.

The routing engine 546 can calculate a navigation event update parameter 344 in a get navigation event routing parameter block 420. The routing engine 546 can calculate the navigation event update parameter 344 based on the driver profile 310 provided by the profile engine 544. The navigation event update parameter 344 can include the mapping parameter 314 provided by the mapping engine 548.

The client control unit 508 can execute the software 504 to provide overall control flow for each block. The client control unit 508 can compare the current location 332 with the primary route in the check primary route navigation block 414 to determine if the device 102 is on the primary route 210. The client control unit 508 can compare the current location 332 to the non-primary route 212 in the check non-primary route navigation block 416 to determine if the device 102 is on one of the non-primary route 212.

The client control unit 508 can determine if the device 102 is not on the primary route 210 or one of the non-primary routes 212 in the check re-route navigation block 418. If the device 102 is not on a known route, the local re-route engine 514 can calculate a route form the current location to a location on the primary route 210 or the non-primary route 212.

The client control unit 508 can update the navigation routing parameter in the update operating parameter block 406. The client control unit 508 can update the navigation event update parameter in the update navigation routing parameter block 422.

The client control unit 508 and the local re-route engine 514 can operate together to present directional navigation information on the multimedia display interface 202 in the perform directional navigation block 424. The local re-route engine 514 can calculate the relative direction from the current location to a point on the known routes.

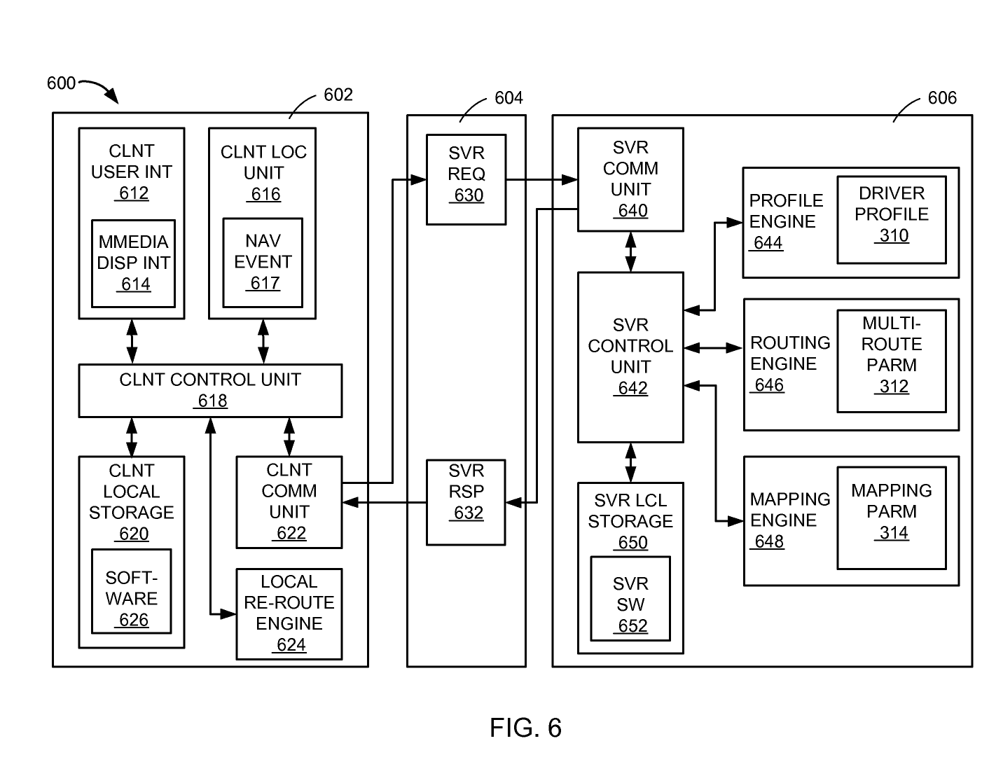

Referring now to FIG. 6, therein is shown a block diagram of the navigation system 600 with predictive multi-routing in a second embodiment of the present invention. FIG. 6 shows a multiple device embodiment of the navigation system 600 with predictive multi-routing where a first device 602 can provide local navigation functionality and a second device 606 can provide data services.

For illustrative purposes, the navigation system 600 with predictive multi-routing is shown with the first device 602 as a client, although it is understood that the navigation system 600 with predictive multi-routing can have the first device 602 as a different type of device. For example, the first device 602 can be a server. For convenience to describe an example of the present invention, the first device 602 will be described as a client.

Also for illustrative purposes, the navigation system 600 with predictive multi-routing is shown with the second device 606 as a server, although it is understood that the navigation system 600 with predictive multi-routing can have the second device 606 as a different type of device. For example, the second device 606 can be a client. For convenience to describe an example of the present invention the second device 606 will be described as a server.

The first device 602 can communicate with the second device 606 over a communication path 604. The first device 602, such as a client, can send a server request 630 to the second device 606 over the communication path 604. The second device 606, such as a server, can send a server response 632 to the first device 602 over the communication path 604. The first device 602 can present the visual and audio navigation and routing information on a multimedia display interface 614.

The first device 602 can include, for example, a client user interface 612 with the multimedia display interface 614, a client location unit 616, a client control unit 618, such as a processor, a software 626, a client local storage 620, a local rerouting engine 624, and a client communication unit 622. The software 626 includes the method of operation of the navigation system 600 or portions thereof.

The client user interface 612 can provide command and data inputs to the first device 602. The client user interface 612 can include the multimedia display interface 614, a key pad, a touchpad, soft-keys, a keyboard, a microphone, or any combination thereof, to provide data and command inputs to the first device 602.

The multimedia display interface 614 can present visual and audio information such as maps, text, video, images, audio commands, audio notifications, audio warning, or any combination thereof. The multimedia display interface 614 can include a flat panel display, projector, cathode-ray tube display, heads up display, speakers, headphones, buzzers, or any combination thereof.

Presenting visual information on the multimedia display interface 614 can include displaying images, graphics, video, text or any combination thereof on the screen or display of the multimedia display interface 614. Presenting audio information on the multimedia display interface 614 can include playing voice, music, audio clips or any combination thereof on the speakers, headphones or buzzers of the multimedia display interface 614.

The client location unit 616 can provide location information and be implemented in many ways. For example, the client location unit 616 can be a global positioning system (GPS), inertial navigation system, cell-tower location system, accelerometer location system, or any combination thereof. The client location unit 616 can include the active and passive components, such as microelectronics or an antenna.

The client location unit 616 can detect the navigation event 340. The navigation event 340 can include location change, speed change, deviation from routing command, vehicle control usage, vehicle control setting change, vehicle instrument change, or any combination thereof.

The local rerouting engine 624 can calculate local or directional routes to locations that exist in the navigation routing parameter 304. The local re-route 342 of FIG. 3 can include street navigation information to define a route between the current location and a location on a known route. The directional route can include a directional navigation command to a point on a known route.

The client control unit 618 can execute the software 626 and can provide the intelligence of the first device 602 for interaction with the client user interface 612, the multimedia display interface 614, the client location unit 616, the client local storage 620, the client communication unit 622, a profile engine 644, a routing engine 646 and a mapping engine 648. The client control unit 618 can also execute the software 626 for other functions pertinent to a navigation device.

The client local storage 620 can be a volatile memory, a nonvolatile memory, an internal memory, an external memory, or a combination thereof. For example, the client local storage 620 can be a nonvolatile storage such as non-volatile random access memory (NVRAM), Flash memory, or disk storage or a volatile storage such as static random access memory (SRAM).

The client local storage 620 can store the software 626, setup data, multimedia data, photos, text, sounds recordings, video and other data for the operation of the first device 602 as a navigation device. The client local storage 620 can also store the relevant information, such as maps, route information, traffic information, advertisement and point of interest (POI), navigation routing entries, driver information, or any combination thereof. The client local storage 620 can also store recorded, imaged, sampled or created relevant information.

The client communication unit 622 can couple with the communication path to communicate with other devices. The client communication unit 622 can include active and passive components, such as microelectronics or an antenna.

The second device 606 can include a number of units, for example, a server control unit 642 such as a processor, a server software 652, a server local storage 650, a server communication unit 640, the profile engine 644, the routing engine 646, and the mapping engine 648. The server software 652 includes the method of operation of the navigation system 600 or portions thereof.

For illustrative purposes, the navigation system 600 with predictive multi-routing is shown with the second device 606 described with discrete functional blocks, although it is understood that the navigation system 600 with predictive multi-routing can have the second device 606 in a different configuration. For example, the server control unit 642, the server communication unit 640, the profile engine 644, the routing engine 646, and the mapping engine 648 may not be discrete functional blocks but may have one or more of the aforementioned blocks combined into one functional block.

In another example, the second device 606 can be implemented as discrete functional blocks that are implemented in one or more computing elements distributed across a network in a cloud computing configuration.

The server control unit 642 can execute the software 626 and can provide the intelligence of the second device 606 for interaction with the first device 602, the profile engine 644, the routing engine 646, the mapping engine 648, and the server local storage 650 the communication system of the communication path 604 via the server communication unit 640.

The profile engine 644 can store, update, and retrieve the driver profile 310 in the server local storage 650 for use by the server control unit 642 of the second device 606. The driver profile 310 can include driver proficiency rating, driver location history, driver vehicle history, driver environmental history, or any combination thereof. The profile engine 644 can be implemented as a local or remote discrete functional block on the second device 606.

The routing engine 646 can create, store, update, and retrieve the multi-route parameter 312 representing a route between two locations for use by the server control unit 642 of the second device 606. The multi-route parameter 312 can include a primary route, non-primary routes, predictive probable deviation locations, vector maps, node and edge weighing information, audio command information, video, graphics, text, or any combination thereof. It is understood that the routing engine 646 can be implemented as a local or remote discrete functional block on the second device 606.

The mapping engine 648 can retrieve the mapping parameter 314 for a location from the server local storage 650 for the operation of the second device 606. The mapping parameter 314 can include location-specific mapping information, graphical display information, resolution and size-specific display tiles, vector maps, or any combination thereof. The mapping engine 648 can be implemented as a local or remote discrete functional block on the second device 606.

The server local storage 650 can store the software, mapping data, routing data, profile data, setup data, multimedia data, traffic information, points of interest, photos, text, audio data, video data, or any combination thereof for the operation of the second device 606. The server local storage 650 can include a memory storage device, such as a disk drive, storage array, network storage, solid-state memory devices, optical storage, magnetic storage, bubble memory, volatile memory, nonvolatile memory, internal memory, external memory, database, or a combination thereof.

The first device 602 and the second device 606 can implement the flow chart of method of the navigation system 100 with predictive multi-routing of FIG. 4. Each block of the flow chart can be implemented using a combination of functional modules of the device 102.

The client user interface 612 of the first device 602 can receive the navigation routing request 302 for the get routing request block 402. The client user interface 612 of the first device 602 can present visual and audio information on the multimedia display interface 614 of the first device 602 for the present navigation information block 408.

The client communication unit 622 can send the server request 630 with the navigation routing request 302 to the second device 606 via the communication path 604 in the get navigation routing parameter block 404. The second device 606 can receive the navigation routing request 302 with the server request 630 in the server communication unit 640 in the get navigation routing parameter block 404.

The second device 606 can send the server response 632 with the navigation routing parameter 304 to the first device 602 via the communication path 604 in the get navigation routing parameter block 404. The first device 602 can receive the server response 632 with the navigation routing parameter 304 in the client communication unit 622 of the first device 602 in the get navigation routing parameter block 404.

The client location unit 616 of the first device 602 can detect the navigation event 340 for the detect navigation event block 410. The client location unit 616 of the first device 602 can provide the location of the device 102 to update the current location in the update location information block 412.

The client control unit 618 of the first device 602 can execute the software 626 to provide overall control of the first device 602. The client control unit 618 of the first device can compare the current location 332 with the primary route 210 in the check primary route navigation block 414 to determine if the first device 602 is on the primary route 210. The client control unit 618 of the first device can compare the current location 332 to the non-primary route 212 in the check non-primary route navigation block 416 to determine if the first device 602 is on one of the non-primary route 212.

The client control unit 618 of the first device 602 can determine if the first device 602 is not on the primary route 210 or one of the non-primary routes 212 in the check re-route navigation block 418. If the first device 602 is not on a known route, the local rerouting engine 624 of the first device can calculate a route from the current location 332 to a location on the primary route 210 or the non-primary route 212.

The client control unit 618 of the first device 602 can update the navigation routing parameter 304 in the update operating parameter block 406. The client control unit 618 of the first device 602 can update the navigation event update parameter 344 in the update navigation routing parameter block 422.

The client control unit 618 of the first device 602 and the local rerouting engine 624 of the first device 602 can operate together to present directional navigation information on the multimedia display interface 614 of the first device 602 in the perform directional navigation block 424. The local rerouting engine 624 of the first device 602 can calculate the relative direction from the current location 332 to a point on the known routes.

The second device 606 can include, for example, the server communication unit 640, the server control unit 642 such as a processor, the server local storage 650, the profile engine 644, the routing engine 646, and the mapping engine 648.

The routing engine 646 of the second device 606 can calculate the navigation routing parameter 304 in the get navigation routing parameter block 404. The routing engine 646 of the second device 606 can calculate the navigation routing parameter 304 based on the driver profile 310 provided by the profile engine 644 of the second device 606. The navigation routing parameter 304 can include the mapping parameter 314 provided by the mapping engine 648 of the second device 606.

The routing engine 646 of the second device 606 can calculate the navigation event update parameter 344 in the get navigation event routing parameter block 420. The routing engine 646 of the second device 606 can calculate the navigation event update parameter 344 based on the driver profile 310 provided by the profile engine 644 of the second device 606. The navigation event update parameter 344 can include the mapping parameter 314 provided by the mapping engine 648 of the second device 606.

It has been discovered that the present invention provides a navigation system 100 with predictive multi-routing that can reduce the number of updates between two devices by initially sending predictive multi-route information. By predicting possible deviation locations in advance, the navigation system can reduce the number of updates required for navigation. This can reduce the amount of remote requests and total amount of network traffic leading to increased performance and reduced costs.

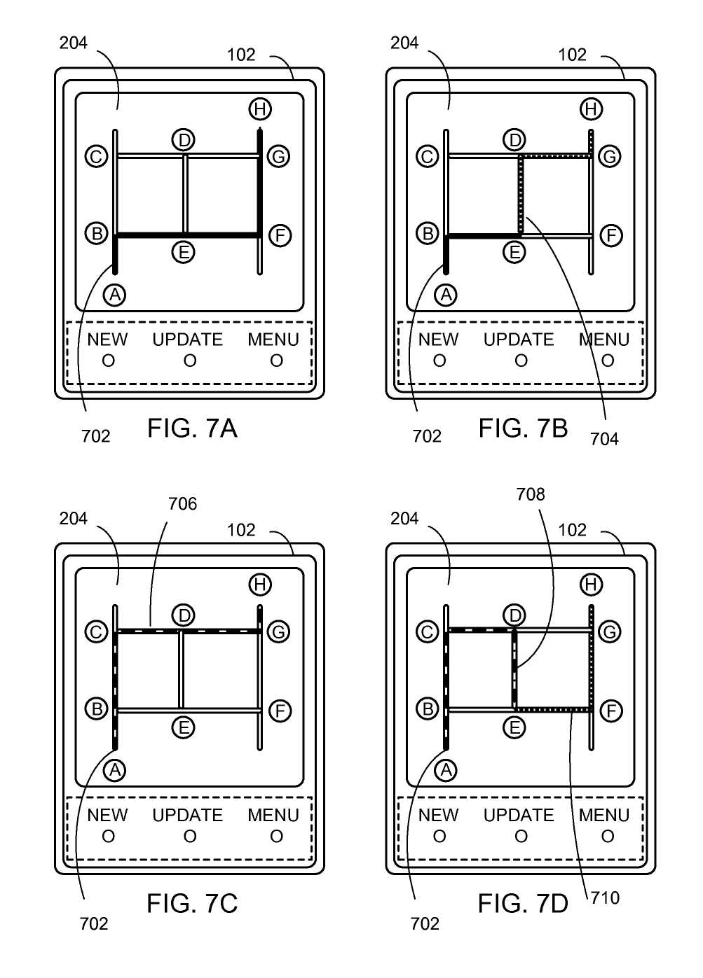

Referring now to FIGS. 7A, 7B, 7C and 7D, therein are illustrations of a first example of the navigation system 100 of FIG. 1.

FIG. 7A shows a primary route 702 from location A to location H along the route ABEFGH on the multimedia display interface 202 of the device 102. The navigation system 100 can calculate the primary route 702 from location A to location H in the routing engine 546 of FIG. 5. The device 102 can display visual and audio information including graphical maps and turn-by-turn audio instruction on the multimedia display interface 202 of FIG. 5 during navigation based on the current location of the device 102.

FIG. 7B illustrates the scenario of the deviation from the primary route 702 at location E to a non-primary route 704 from location E to location H along the route EDGH. The non-primary route 704 is based on the probable point of deviation at location E on the primary route 702. The deviation at location E triggers the detection of the navigation event 340 and the device 102 can match the updated location on the ED edge to the non-primary route 704 in the client local storage 510 of FIG. 5. The non-primary route 704 can become the new version of the current route 336 used for navigation to location H.

FIG. 7C illustrates the scenario of a deviation from the primary route 702 at location B to a non-primary route 706 from location B to location H along the route BCDGH. The non-primary route 706 is based on a probable point of deviation at location B on the primary route 702. The deviation at location B triggers the detection of the navigation event 340. The device 102 can match the updated location on the BC edge to the non-primary route 7046 in the client local storage 510. The non-primary route 704 can become the new version of the current route 336 used for navigation to location H.

FIG. 7D illustrates the scenario of the deviation at location D while on a non-primary route 708 from location B to location H. Location D is not on the original version of the primary route 702 and is not a probable point of deviation from the primary route 702. There are no non-primary routes in the client local storage 510 based on a deviation at location D. The deviation at D triggers detection of the navigation event 340 resulting in a location update to edge DE which does not match a non-primary route in the client local storage 510.

The device 102 can use the local re-route engine 514 from FIG. 5 to calculate a local re-route 710 from the current location on edge DE to a primary or non-primary route stored in the client local storage 510. The local re-route 710 connects to the primary route 702 along route ABEFGH at location E and the device 102 can present navigation information on the multimedia display interface 202 to navigate to location E and continue navigation to location H using the primary route 702 from location E to location H along the route EFGH.

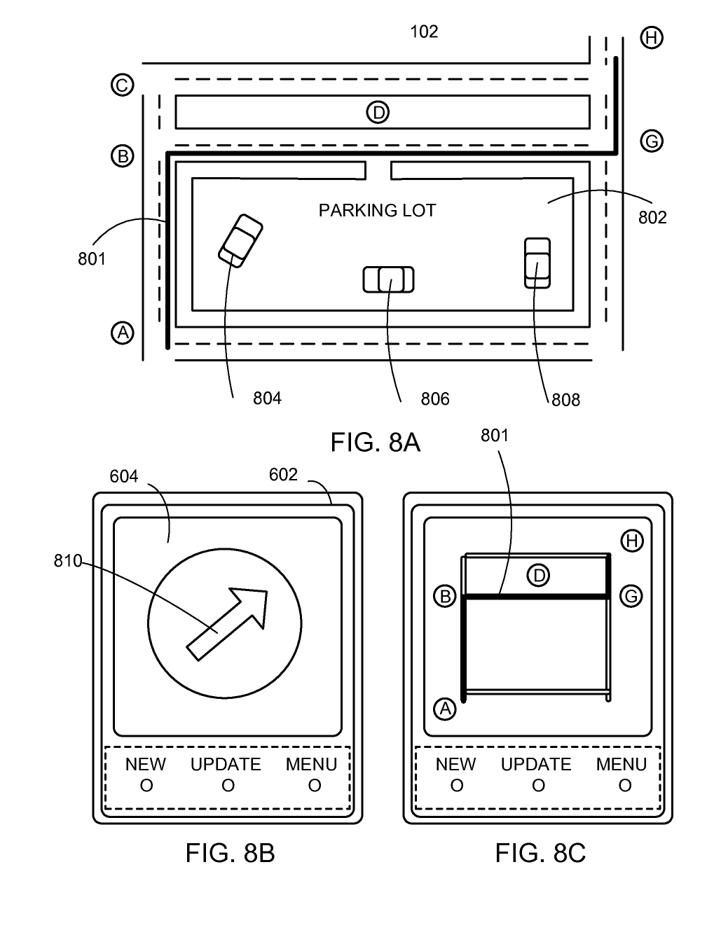

Referring now to FIGS. 8A, 8B, and 8C, therein are illustrations of a second example of the navigation system 100 of FIG. 1.

FIG. 8A shows a representation of the first device 602 of FIG. 6 operating in an undefined navigation area 802 that does not include navigable features. The undefined navigation area 802 can include areas such as parking lots, open lots, open land, pedestrian areas, buildings, walkways, or any combination thereof.

The first device 602 can deviate from a current route 801 into the undefined navigation area 802 and trigger the navigation event 340 of FIG. 3 resulting in an updated current location 332 of FIG. 3. The first device 602 can navigate using local navigation within the undefined navigation area 802 any number of times without having to communicate with the second device 606 of FIG. 6. For example, the first device 602 can navigate using directional navigation within the undefined navigation area 802 as shown by the vehicle symbols at locations 804, 806, and 808.

FIG. 8B shows the navigation event 340 of FIG. 3 resulting in an updated current location in the undefined navigation area 802 of FIG. 8A. The first device 602 can present a directional indicator 810 on the multimedia display interface 614 to indicate the direction to an accessible location on the current route 801.

The directional indicator 810 can update each time the first device 602 changes location and generates the navigation event 340. The first device 602 can display the directional indicator 810 until the navigation event 340 results in the current location 332 on a street or other navigable feature that leads to a location on the primary route 801.

The first device 602 can display the directional indicator 810 in a local mode to avoid the need to retrieve new routing information from the second device 606. This can allow the navigation system 100 with predictive multi-routing to operate quickly and with a reduced data transmission requirement in situations where local navigation is sufficient to operate the system.

In FIG. 8C, the first device 602 intercepts the primary route 801 at location D and resumes presenting the visual and audio information to navigate to the location H along the route DGH.

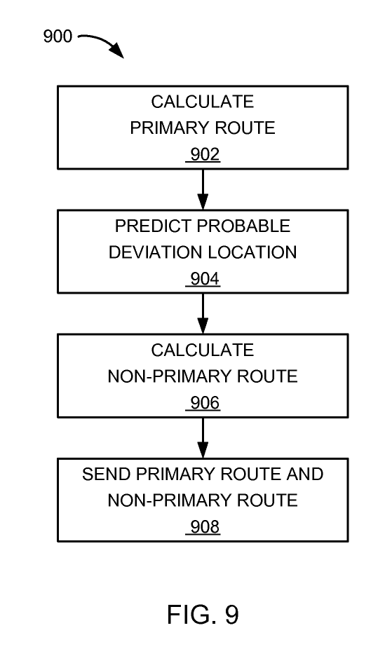

Referring now to FIG. 9, therein is shown a flow chart of a method 900 of operation of the navigation system 100 in a further embodiment of the present invention. The method 900 includes calculating the primary route in a block 902, predicting the probable deviation locations along the primary route in a block 904, calculating the non-primary route in a block 906, and sending the primary route, the non-primary route or a combination thereof for displaying on a device in a block 908.

Yet another important aspect of the present invention is that it valuably supports and services the historical trend of reducing costs, simplifying systems, and increasing performance. These and other valuable aspects of the present invention consequently further the state of the technology to at least the next level.

Thus, it has been discovered that the navigation system with predictive multi-routing of the present invention furnishes important and heretofore unknown and unavailable solutions, capabilities, and functional aspects for improving performance, increasing reliability, increasing safety and reducing cost of using a mobile client having location based services capability. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations can be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a navigation system comprising:
calculating a primary route;
predicting a probable deviation location on the primary route;
calculating a non-primary route for the probable deviation location; and
sending the primary route, the non-primary route, or a combination thereof for displaying on a device.

2. The method as claimed in claim 1 wherein:
calculating the primary route includes identifying an edge in the primary route; and
predicting the probable deviation location includes calculating the probability of deviation for the edge.

3. The method as claimed in claim 1 wherein predicting the probable deviation location on the primary route includes:
providing a probable deviation threshold;
identifying a probability of deviation that meet or exceed the probable deviation threshold; and
identifying the probable deviation location with the probability of deviation.

4. The method as claimed in claim 1 further comprising:
detecting a current location off the primary route and the non-primary route; and
updating the primary route based on the current location.

5. The method as claimed in claim 1 further comprising:
detecting a current location off the primary route and the non-primary route; and
navigating a local re-route from the current location to the primary route or the non-primary route.

6. A method of operation of a navigation system comprising:
calculating a primary route;
detecting a current location off the primary route;
predicting a probable deviation location on the primary route;
calculating a non-primary route for the probable deviation location;
calculating a navigation event update parameter with a multi-route parameter and a mapping parameter; and
sending the navigation event update parameter for displaying on a device.

7. The method as claimed in claim 6 wherein predicting the probable deviation location on the primary route includes calculating an edge weight parameter for an edge along the primary route.

8. The method as claimed in claim 6 wherein calculating the navigation event update parameter includes varying a probable deviation threshold.

9. The method as claimed in claim 6 further comprising updating a current route with the non-primary route.

10. The method as claimed in claim 6 further comprising updating the current route with a local re-route.

11. A navigation system comprising:
a routing engine for:
calculating a primary route, and
calculating a non-primary route for a probable deviation location;
a control unit, coupled to the routing engine, for:
predicting the probable deviation location on the primary route, and
updating a navigation routing parameter with a multi-route parameter; and
a communication unit, coupled to the control unit, for:
sending the primary route, the non-primary route, or a combination thereof for displaying on a device.

12. The system as claimed in claim 11 wherein:
the routing engine is for calculating the primary route includes identifying an edge in the primary route; and
the control unit is for predicting the probable deviation location includes calculating the probability of deviation for the edge.

13. The system as claimed in claim 11 wherein the control unit is for:
providing a probable deviation threshold;
identifying a probability of deviation that meet or exceed the probable deviation threshold; and
identifying the probable deviation location with the probability of deviation.

14. The system as claimed in claim 11 further comprising:
a location unit, coupled to the control unit, for detecting a current location; and
wherein the control unit is for:
detecting the current location off the primary route and the non-primary route; and
updating the primary route based on the current location.

15. The system as claimed in claim 11 further comprising:
a location unit, coupled to the control unit, for detecting a current location;
a local re-route engine, coupled to the control unit, for navigating a local re-route from the current location to the primary route or the non-primary route; and
wherein:
the control unit is for detecting the current location off the primary route and the non-primary route.

16. The system as claimed in claim 11 further comprising:
a location unit, coupled to the control unit, for detecting a current location; and
wherein the control unit is for:
detecting the current location off the primary route and the non-primary route; and
calculating a navigation event update parameter with a multi-route parameter and a mapping parameter.

17. The system as claimed in claim 16 wherein the control unit is for calculating an edge weight parameter for an edge along the primary route.

18. The system as claimed in claim 16 wherein the control unit is for varying a probable deviation threshold.

19. The system as claimed in claim 16 wherein the control unit is for updating a current route with the non-primary route.

20. The system as claimed in claim 16 wherein the control unit is for updating a current route with a local re-route.
